(19) United States
(12) Patent Application Publication
(10) Pub. No.: US 2024/0158690 A1
(43) Pub. Date: May 16, 2024

(54) COMPOSITE CHROMOGENIC COMPOSITIONS AND APPLICATIONS THEREOF

(71) Applicant: The University Of North Carolina at Charlotte, Charlotte, NC (US)

(72) Inventors: Tyler Joseph Adams, Charlotte, NC (US); Michael walter, Charlotte, NC (US)

(21) Appl. No.: 18/281,219

(22) PCT Filed: Mar. 10, 2022
(86) PCT No.: PCT/US2022/019699

§ 371 Date: Sep. 8, 2023

Related U.S. Application Data
(60) Provisional application No. 63/158,929, filed on Mar. 10, 2021.

(51) Int. Cl. C09K 9/02; C08K 5/47; G02F 1/1516

(52) U.S. Cl. CPC C09K 9/02; C08K 5/47; G02F 1/1516; C09K 2211/1018

(57) ABSTRACT

Chromogenic compositions and devices are described herein which, in some embodiments, permit facile and environmentally friendly production while exhibiting efficient and reversible electrochromic activity. In some embodiments, a composite composition comprises one or more chromogenic thiazolothiazoles contained in an aqueous-based polyelectrolyte matrix. The one or more chromogenic thiazolothiazoles can be soluble in the aqueous-based polyelectrolyte matrix, in some embodiments. Moreover, the chromogenic thiazolothiazoles can comprise at least two pyridinium moieties. In some embodiments, the chromogenic thiazolothiazoles undergo a first color change in response to a first electron reduction, and a second color change in response to a second electron reduction.

### RELATED APPLICATION DATA

The present application claims priority to U.S. Provisional Patent Application Ser. No. 63/158,929 filed Mar. 10, 2021 which is hereby incorporated by reference in its entirety.

### FIELD

The present invention is related to chromogenic compositions and, in particular, to compositions and devices employing chromogenic molecular species contained in aqueous-based polymeric matrices.

### BACKGROUND

Electrochromic devices (ECDs) have gained interest for use in tinting eyeglasses, auto-darkening mirrors, wearable electronics, glucose detection biosensors, energy storage, and tinting windows in buildings, cars, or airplanes. Similarly, photochromic systems are often sought after for tinting eyeglasses and windows, whereas electrofluorochromics (EFCs) are applicable for displays, biosensors, or chemical sensors. Although inorganic materials possess some of these qualities, there is currently a larger focus on organic materials because of high contrast, fast response, processability, and cost efficiency. Previously researched EC organic molecules generally include benzonitriles, symmetric and asymmetric viologens, and thioxathone viologens.

There has also been a large interest in EC polymers, including those utilizing thiazolothiazole, thiophene, and benzothiadiazole moieties. Some materials, like phthalates, poly(4-cyanotriphenylamine), thienoviologen ionic liquid crystals, and a variety of liquid crystal materials are also electrofluorochromic. Arylamines have also been used as a redox site with extended conjugation substituents to yield highly reversible high contrast electrochromic and electrofluorochromic devices. Thienoviologen extended viologens also show high fluorescence quantum yields and extreme contrast ratios of up to 337. There exists a wide variety of organic photochromic materials that change their absorbance when switching between dark and light intensive environments, or switching between UV and visible wavelengths. Some compounds like diarylethene containing triphenylamine, pentaarylbiimidazole, phenoxyl-imidazolyl radical complex, and rhodamine B salicylaldehyde hydrazone metal complexes show strong photochromic color change properties. The development of organic materials that could exhibit all three properties (electrochromic, electrofluorochromic, and photochromic) is an attractive pursuit for a wide variety of applications.

### SUMMARY

In view of the foregoing, chromogenic compositions and devices are described herein which, in some embodiments, permit facile and environmentally friendly production while exhibiting efficient and reversible electrochromic activity. In some embodiments, a composite composition comprises one or more chromogenic thiazolothiazoles contained in an aqueous-based polyelectrolyte matrix. The one or more chromogenic thiazolothiazoles can be soluble in the aqueous-based polyelectrolyte matrix, in some embodiments. Moreover, the chromogenic thiazolothiazoles can comprise at least two pyridinium moieties. In some embodiments, the chromogenic thiazolothiazoles undergo a first color change in response to a first electron reduction, and a second color change in response to a second electron reduction. The first and second color changes are reversible via oxidation, thereby providing color cycling of the chromogenic thiazolothiazoles. As described further herein, the polyelectrolyte matrix, in some embodiments, comprises a hydrogel.

In another aspect, chromogenic devices are provided. A chromogenic device, in some embodiments, comprises an active layer arranged between a first electrode and a second electrode, the active layer comprising one or more chromogenic thiazolothiazoles contained in an aqueous-based polyelectrolyte matrix. At least one of the first and second electrodes, in some embodiments, is transmissive in the visible region of the electromagnetic spectrum. The polyelectrolyte matrix can be a hydrogel containing the one or more chromogenic thiazolothiazoles. In some embodiments, the device is at least one of electrochromic, electrofluorochromic, and photochromic.

In another aspect, methods of providing or making chromogenic devices are described herein. In some embodiments, a method comprises positioning an active layer between a first electrode and a second electrode, the active layer comprising one or more chromogenic thiazolothiazoles contained in an aqueous-based polyelectrolyte matrix. The method can further comprise applying voltage to the first and second electrodes to change color of the active layer in response to a first electron reduction of the chromogenic thiazolothiazoles, and a second electron reduction of the chromogenic thiazolothiazoles. The color change of the active layer can be reversed via oxidation of the chromogenic thiazolothiazoles.

These and other embodiments are further described in the following detailed description.

### BRIEF DESCRIPTION OF THE DRAWINGS

FIG. 1 illustrates various non-limiting chromogenic thiazolothiazole compounds for use in embodiments described herein.

FIG. 2 illustrates various moieties for R₁ and R₂ of the thiazolothiazole compounds of FIG. 1.

FIG. 3 illustrates non-limiting embodiments of chromogenic thiazolthiazoles incorporated into the polyelectrolyte backbone.

FIG. 4 illustrates non-limiting embodiments of chromogenic thiazolothiazoles serving as side chains of the polyelectrolyte.

FIG. 5 illustrates non-limiting embodiments of chromogenic thiazolothiazoles crosslinking polyelectrolyte chains of the hydrogel.

FIG. 6 illustrates first and second electron reductions of a thiazolothiazole according to some embodiments.

FIG. 7 illustrates synthesis of various chromogenic thiazolothiazole compounds for use in devices according to some embodiments.

FIG. 8 illustrates fabrication of a chromogenic device described herein according to some embodiments.

FIG. 9 illustrates a first color change in response to a first electron reduction, and a second color change in response to a second electron reduction according to some embodiments.

FIGS. 10(a)-10(c) illustrate transmittance spectra of Me₂TTz²⁺ at varying voltages (0 V, 1 V, 1.5 V, 2 V, 2.5 V) and varying concentrations of Fc(CH₂OH)₂.

FIGS. 11(a)-11(c) illustrate transmittance spectra of (NPr)₂TTz⁴⁺ at varying voltages (0 V, 1 V, 1.5 V, 2 V, 2.5 V) and varying concentrations of Fc(CH₂OH)₂.

FIGS. 12(a)-12(c) illustrate transmittance spectra of (SPr)₂TTz at varying voltages (0 V, 1 V, 1.5 V, 2 V, 2.5 V) and varying concentrations of Fc(CH₂OH)₂.

FIGS. 13(a)-13(c) illustrate transmittance spectra of Bz₂TTz²⁺ at varying voltages (0 V, 1 V, 1.5 V, 2 V, 2.5 V) and varying concentrations of Fc(CH₂OH)₂.

FIG. 14(a) are transmittance spectra of 1:2 Me₂TTz²⁺:Fc(CH₂OH)₂ at 0-2.5V.

FIG. 14(b) are transmittance spectra of 1:2 (NPr)₂TTz⁴⁺:Fc(CH₂OH)₂ at 0-2.5V.

FIG. 14(c) are transmittance spectra of 1:2 (SPr)₂TTz:Fc(CH₂OH)₂ at 0-2.5V.

FIG. 14(d) are transmittance spectra of 1:2 Bz₂TTz²⁺:Fc(CH₂OH)₂ at 0-2.5V.

FIG. 15(a) are 1:2 (NPr)₂TTz⁴⁺:Fc(CH₂OH)₂ CGD transmittance spectra when the devices were cycled on/off 0 V/1.8 V (20 s on/off) for 250 cycles (710 nm).

FIG. 15(b) illustrates 1:2 (NPr)₂TTz⁴⁺:Fc(CH₂OH)₂ CGD transmittance spectra when the devices were turned on (1.8 V) for 60 min (710 nm).

FIG. 16(a) illustrates fluorescence of 1:2 Bz₂TTz²⁺:Fc(CH₂OH)₂ CGDs at 0 V, 1 V, 1.5 V, 2 V, 2.5 V (λₑₓ=419 nm).

FIG. 16(b) illustrates fluorescence of 1:2 Bz₂TTz²⁺:Fc(CH₂OH)₂ CGDs cycled (20 s on/off 0 V/1.8 V) 25 cycles (λₑₓ=419 nm, λₑₘ=463 nm).

FIG. 17(a) are photochromism spectra of 1:2 (NPr)₂TTz⁴⁺:Fc(CH₂OH)₂ with 1-30 minutes of 100 mW cm⁻² illumination without applied voltage (inset images of TTz gel device illuminated for 15 and 25 min).

FIG. 17(b) are photochromism spectra of 1:2 (NPr)₂TTz⁴⁺:Fc(CH₂OH)₂ with 1-30 minutes of 100 mW cm⁻² illumination with 0.8 V applied.

FIG. 17(c) illustrates photochromism engaged and then turned off by electrochromic cycling of the device.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

### Definitions

The term “alkyl” as used herein, alone or in combination, refers to a straight or branched saturated hydrocarbon group. For example, an alkyl can be C₁-C₃₀.

The term “alkenyl” as used herein, alone or in combination, refers to a straight or branched chain hydrocarbon group having at least one carbon-carbon double bond.

The term “aryl” as used herein, alone or in combination, refers to an aromatic monocyclic or multicyclic ring system optionally substituted with one or more ring substituents

The term “heteroaryl” as used herein, alone or in combination, refers to an aromatic monocyclic or multicyclic ring system in which one or more of the ring atoms is an element other than carbon, such as nitrogen, oxygen and/or sulfur.

The term “cycloalkyl” as used herein, alone or in combination, refers to a non-aromatic, saturated mono- or multicyclic ring system optionally substituted with one or more ring substituents.

The term “cycloalkenyl” as used herein, alone or in combination, refers to a non-aromatic, mono- or multicyclic ring system having at least one carbon-carbon double bond and is optionally substituted with one or more ring substituents.

The term “heterocycloalkyl” as used herein, alone or in combination, refers to a non-aromatic, saturated mono- or multicyclic ring system in which one or more of the atoms in the ring system is an element other than carbon, such as nitrogen, oxygen or sulfur, alone or in combination, and wherein the ring system is optionally substituted with one or more ring substituents.

The term “heterocycloalkenyl” as used herein, alone or in combination, refers to a non-aromatic, mono- or multicyclic ring system in which one or more of the atoms in the ring system is an element other than carbon, such as nitrogen, oxygen or sulfur, alone or in combination, and which contains at least one carbon-carbon double bond in the ring system and wherein the ring system is optionally substituted with one or more ring substituents.

The term “heteroalkyl” as used herein, alone or in combination, refers to an alkyl moiety as defined above, having one or more carbon atoms, for example one, two or three carbon atoms, replaced with one or more heteroatoms, which may be the same or different.

The term “multicyclic ring system” as used herein, alone or in combination, refers to fused ring systems or non-fused ring systems linked together by one or more spacer moieties.

### I. Composite Compositions

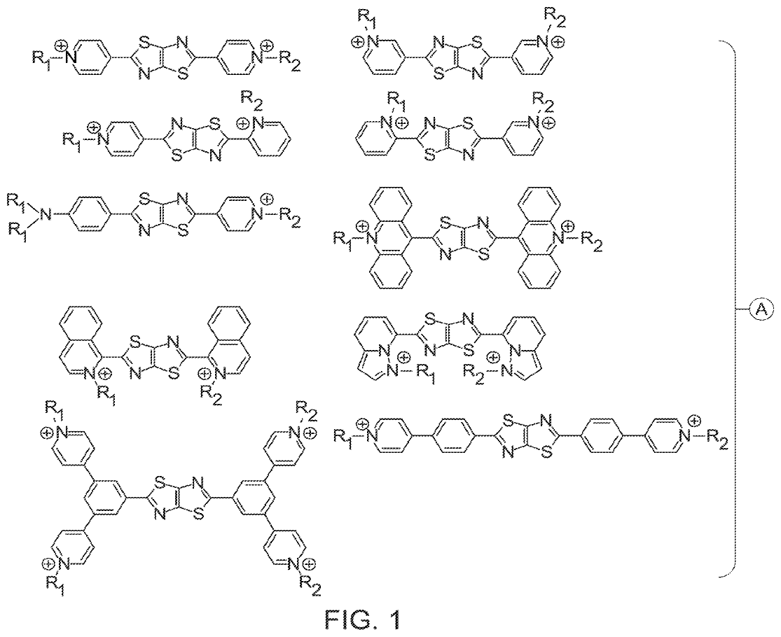

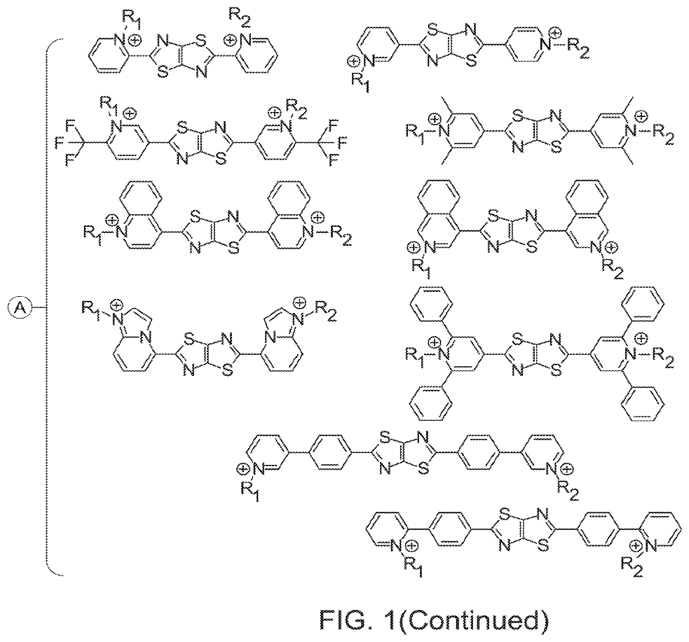

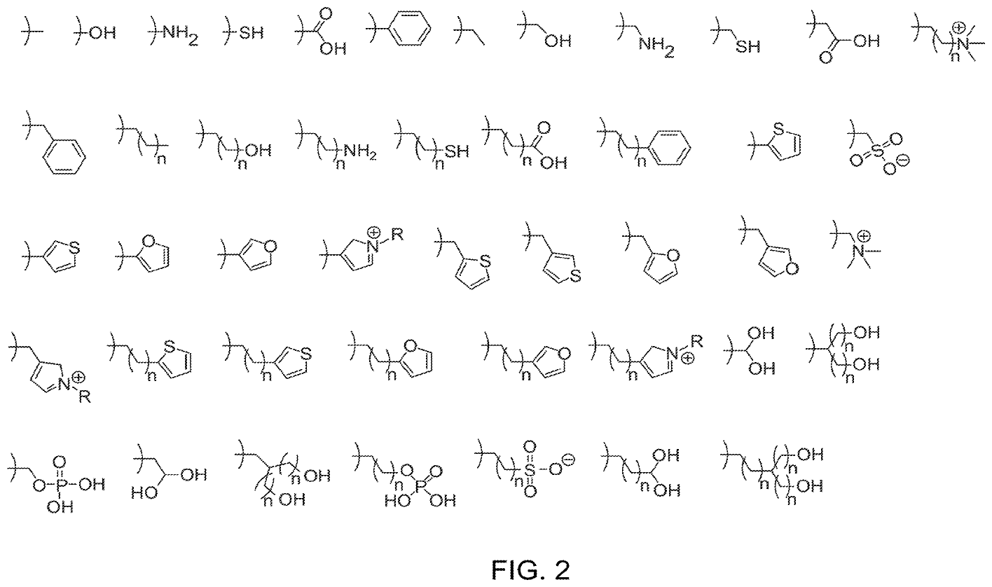

In some embodiments, a composite composition comprises one or more chromogenic thiazolothiazoles contained in an aqueous-based polyelectrolyte matrix. In some embodiments, the chromogenic thiazolothiazoles comprise at least two pyridinium moieties. Moreover, in some embodiments, the one or more chromogenic thiazolothiazoles include a thiazolo(5,4-d)thiazole heterocycle structure. Chromogenic thiazolothiazole compounds suitable for use in composite compositions and active layers described herein can be of the formula:

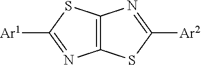

wherein Ar¹ and Ar² are heteroaryl, each containing at least one pryidinium moiety. Nitrogens of the pryridinium moieties may be independently substituted with a substituent selected from the group consisting of hydrogen, alkyl, alkenyl, cycloalkyl, heterocycloalkyl, aryl, heteroaryl, -alkyl-aryl, -alkyl-heteroaryl, hydroxy, amine, thiol, —R¹—OH, —R²—C(O)OH, sulfonic, and phosphonic, wherein R¹ and R² are independently selected from the group consisting of alkyl and alkenyl. FIG. 1 illustrates various non-limiting chromogenic thiazolothiazole compounds for use in embodiments described herein. FIG. 2 illustrates various moieties for R₁ and R₂ of the thiazolothiazole compounds of FIG. 1. R₁ and R₂ may be the same or different in the thiazolothiazoles of FIG. 1. Chromogenic thiazolothiazoles can be symmetric or asymmetric. Additionally, the one or more chromogenic thiazolothiazoles are at least one of electrochromic, electrofluorochromic, and photochromic. In some embodiments, the one or more chromogenic thiazolothiazoles are electrochromic, electrofluorochromic, and photochromic.

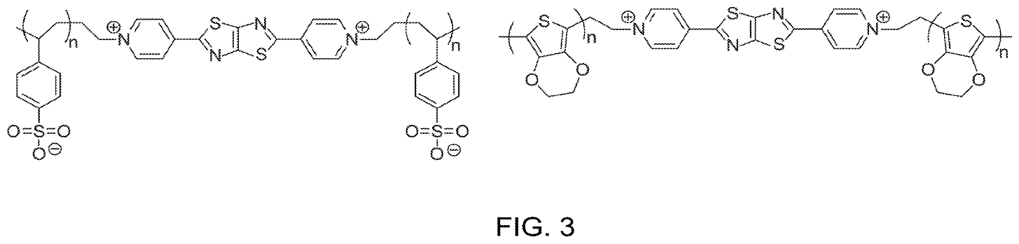

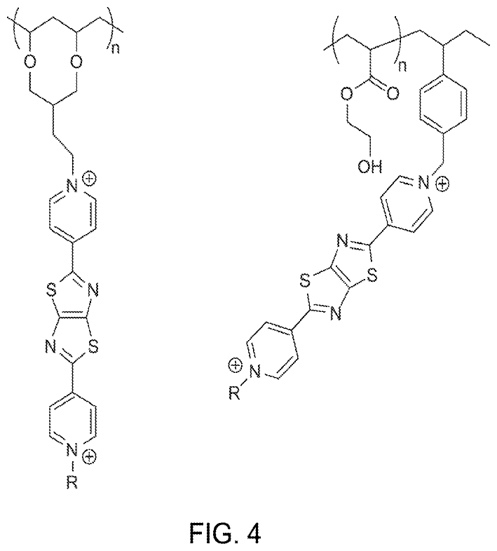

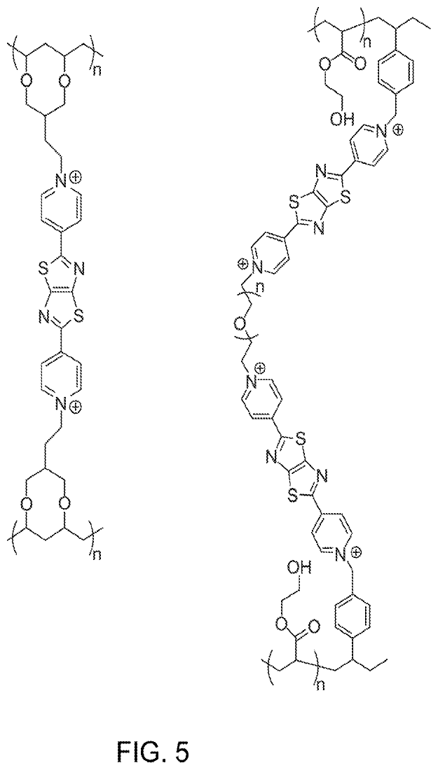

The one or more chromogenic thiazolothiazoles can be soluble in the aqueous-based polyelectrolyte matrix. As described further herein, the polyelectrolyte matrix can comprise a hydrogel or is formed of a hydrogel. In such embodiments, chromogenic thiazolothiazoles may be solubilized in the aqueous or aqueous-based phase of the hydrogel. Chromogenic thiazolothiazole compounds, in some embodiments, are directly associated with polyelectrolyte of the hydrogel. For example, the one or more chromogenic thiazolothiazoles can be incorporated into the polyelectrolyte backbone. FIG. 3 illustrates non-limiting embodiments of chromogenic thiazolothiazoles incorporated into the polyelectrolyte backbone. In some embodiments, chromogenic thiazolothiazoles are provided as side chains or crosslinking components of the polyelectrolyte forming the hydrogel. FIG. 4 illustrates non-limiting embodiments of chromogenic thiazolothiazoles serving as side chains of the polyelectrolyte. FIG. 5 illustrates non-limiting embodiments of chromogenic thiazolothiazoles crosslinking polyelectrolyte chains of the hydrogel.

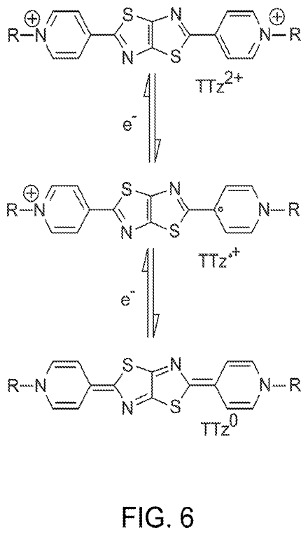

Chromogenic thiazolothiazoles, in some embodiments, undergo a first color change in response to a first electron reduction, and a second color change in response to a second electron reduction. The first and second color changes are reversible via oxidation, thereby providing color cycling of the chromogenic thiazolothiazoles. FIG. 6 illustrates first and second electron reductions of a thiazolothiazole according to some embodiments. Color changes of the thiazolothiazoles can occur in the visible region of the electromagnetic spectrum. In some embodiments, the first and second color changes exhibit independent absorption maxima in the visible region.

One or more chromogenic thiazolothiazole compounds can be present in the aqueous-based polyelectrolyte matrix in any amount consistent with the technical objectives described herein. Amount of chromogenic thiazolothiazole can be selected according to several considerations including, but not limited to, chemical identity of the thiazolothiazole, solubility of the thiazolothiazole in the aqueous-based polyelectrolyte matrix, desired color change characteristics of the composite composition, and/or compatibility of the thiazolothiazole with other components in the composite composition. In some embodiments, chromogenic thiazolothiazole compound is present at a concentration of 10 μM to 1 M.

As described herein, the aqueous-based polyelectrolyte matrix can comprise or be formed of a hydrogel. Any hydrogel consistent with the objectives described herein can be employed. Suitable hydrogel matrices can be selected according to several considerations including, but not limited to, identity of the chromogenic thiazolothiazole compound(s) contained in the matrix, transmittance of the hydorgel in the visible region of the electromagnetic spectrum, and/or desired viscosity of the hydrogel matrix. In some embodiments, the aqueous-based polyelectrolyte matrix is a hydrogel selected from Table I.

TABLE I
Hydrogels

Poly(vinyl alcohol)/Borax
Sodium Carboxymethylcellulose
Polyacrylamide
Hyaluronic acid
Chitosan
Heparin
Alginate
Fibrin
Polyethylene glycol
Sodium polyacrylate
Acrylate polymers
Poly(vinyl butyrate) PVB
Phytic Acid-G Qaudruplex Hydrogel
Poly(methyl methacrylate)
(PMMA)/poly(hydroxypropyl acrylate (PHPA)

In some embodiments, a hydrogel matrix exhibits a peak transmittance in the visible region of 50-90 percent or 50-80 percent.

In some embodiments, hydrogels that do not comprise polyelectrolyte(s) can be employed as the aqueous-based matrix comprising the one or more chromogenic thiazolothiazoles. In such embodiments, one or more free electrolytes can be added to the hydrogel. Electrolytes can comprise one or more alkali metal salts, including lithium chloride, sodium chloride, and/or sodium sulfate.

Composite compositions described herein can further comprise one or more components in addition to the aqueous-based polyelectrolyte matrix and chromogenic thiazolothiazole compounds. In some embodiments, for example, the composite layer further comprises a redox complimentary component. Suitable redox complimentary components, in some embodiments, include ferrocenedimethanol, trimethylaminoferrocene, ferricyanide/ferrocyanide or TEMPO or derivatives thereof. The redox complimentary component can be present in any amount consistent with the technical objectives described herein. In some embodiments, a ratio of the chromogenic thiazolothiazoles to the redox complimentary component ranges from 1:0.1 to 1:5.

In some embodiments, the composite composition can further comprise one or more electrolytes in addition to the hydrogel. One or more electrolytes can be solubilized in the aqueous-based hydrogel matrix. Electrolytes can comprise one or more alkali metal salts, including lithium chloride, sodium chloride, and/or sodium sulfate.

The polyelectrolyte matrix of the composite composition can assume a number of shapes and/or configurations, thereby facilitating use of the composite composition in a number of applications, including active layers for optoelectronic devices.

### II. Chromogenic Devices

In another aspect, chromogenic devices are provided. In some embodiments, a chromogenic device comprises an active layer positioned between a first electrode and a second electrode, the active layer comprising one or more chromogenic thiazolothiazoles contained in an aqueous-based polyelectrolyte matrix. The components of the active layer, including the chromogenic thiazolodithiazoles and polyeletrolyte matrix can have any composition, structure, and/or properties recited in Section I above. For example, the active layer can comprise any chromogenic thiazolothiazole recited in Section I, and the polyelectrolyte matrix can comprise a hydrogel as described in Section I.

In some embodiments, at least one of the first and second electrodes is radiation transmissive. For example, both electrodes can be radiation transmissive. In being radiation transmissive, an electrode is operable to pass radiation in the visible region of the electromagnetic spectrum. A radiation transmissive electrode can pass radiation over the entire visible region or a portion of the visible region. Suitable radiation transmissive oxides include fluorine doped tin oxide (FTO), tin doped indium oxide (ITO), gallium indium tin oxide (GITO), aluminum tin oxide (ATO) and zinc indium tin oxide (ZITO). In some embodiments, a radiation transmissive first and/or second electrode is formed of a radiation transmissive polymeric material such as polyaniline (PANI) and its chemical relatives or 3,4-polyethylenedioxythiophene (PEDOT). Further, a radiation transmissive first and/or second electrode can be formed of a carbon nanotube layer having a thickness operable to at least partially pass visible electromagnetic radiation. An additional radiation transmissive material can comprise a nanoparticle phase dispersed in a polymeric phase.

As described in Section I above, the one or more chromogenic thiazolothiazoles of the active layer undergoe a first color change in response to a first electron reduction, and a second color change in response to a second electron reduction. The first and second color changes are reversible via oxidation. In some embodiments, a change in active layer transmittance between oxidized and two electron reduced forms of the chromogenic thiazolothiazoles is at least 50 percent at one or more wavelengths in the visible region of the electromagnetic spectrum. The change in active layer transmittance, for example, can be 55-80 percent. Moreover, in some embodiments, the change in active layer transmittance at one or more wavelengths in the visible region is 55-80 percent after cycling the chromogenic thiazolothiazoles between oxidized and reduced forms at least 25 times or at least 100 times.

Such stability renders devices described herein suitable for a wide variety of applications. The devices can be used in electronic display and other optoelectronic devices. In some embodiments, the devices can be coupled to waveguides for delivering light to the desired areas. Moreover, the devices can be employed in various smart technologies that respond to external stimuli by changing color. The devices, for example, can be a component of smart windows that dim or otherwise change color in response to the intensity of sunlight or other radiation. As shown in the examples below, a device is at least one of electrochromic, electrofluorochromic, and photochromic. In some embodiments, a device is electrochromic, electrofluorochromic, and photochromic. In being photochromic, devices described herein, in some embodiments, are employed in solar powered battery charging applications.

In a further aspect, methods of providing or making chromogenic devices are described herein. In some embodiments, a method comprises positioning an active layer between a first electrode and a second electrode, the active layer comprising one or more chromogenic thiazolothiazoles contained in an aqueous-based polyelectrolyte matrix. The method can further comprise applying voltage to the first and second electrodes to change color of the active layer in response to a first electron reduction of the chromogenic thiazolothiazoles, and a second electron reduction of the chromogenic thiazolothiazoles. The color change of the active layer can be reversed via oxidation of the chromogenic thiazolothiazoles.

These and other embodiments are further illustrated in the following non-limiting examples.

### Example 1—Multifunctional Chromogenic Devices

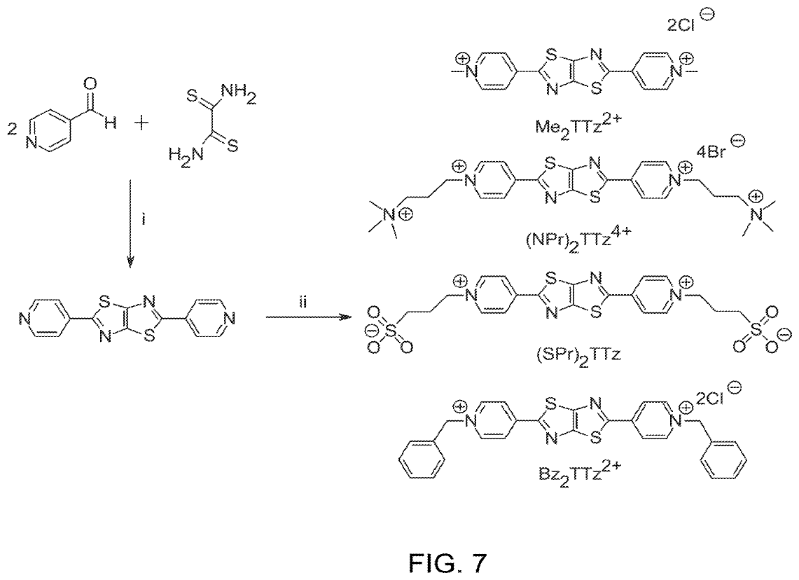

In this example, multifunctional chromogenic devices (electrochromic, electrofluorochromic, and photochromic) are demonstrated using extended TTz viologens developed for low cost, non-toxic, water-based hydrogel devices. The chromogenic devices (CGDs) are highly reversible and stable, have fast-switching times, and exhibit stable, multichromic properties. Various TTz derivatives (FIG. 7) were examined to study how various alkyl groups on the dipyridyl TTz core affect the solubility, device contrast, reversibility, and fluorescence when included in a polyvinyl alcohol (PVA)/borax polyelectrolyte gel CGD. The TTz dyes have two distinct single electron reductions which cause high contrast, visually apparent polyelectrochromic color changes from colorless/light yellow (TTz²⁺) to purple (TTz^{⋅+}) to blue (TTz⁰). The CGDs also show fast on/off switching of the fluorescence intensity. The full range of electrochromic, electrofluorochromic, and photochromic characteristics of these devices was explored and their performance analyzed when modulating color changes and fluorescence initiated electrochemically and/or photochemically.

In this example, the four water soluble TTz derivatives of FIG. 7 were studied in PVA/borax hydrogel devices to achieve low-cost, easily assembled, air-stable, water-based CGDs. The developed TTz's are of interest because of their solubility, oxidative stability in air, two single electron reductions, and high fluorescence quantum yields (Φ_{F}=85-98%). The four alkylated TTz derivatives have similar absorbance and fluorescence properties, with max absorbance at 390-397 nm and max fluorescence at 454-461 nm in aqueous solutions. Previously studied TTz viologens exhibited two reductions that were very close in potential in organic solvents, and therefore, only a single color change was observed in an electrochromic device. Their electrochromic and electrofluorochromic activity was also sensitive to ambient conditions. In the present work, an air-stable TTz aqueous derivatives in a hydrogel device shows two distinct color changes from colorless/light yellow to purple to blue representing both the 1^{st} and 2^{nd} electrochemical reduction (FIG. 6). The full electrochromic, electrofluorochromic, photochromic, device stability, and switching time characteristics are presented herein.

### Electrochromism

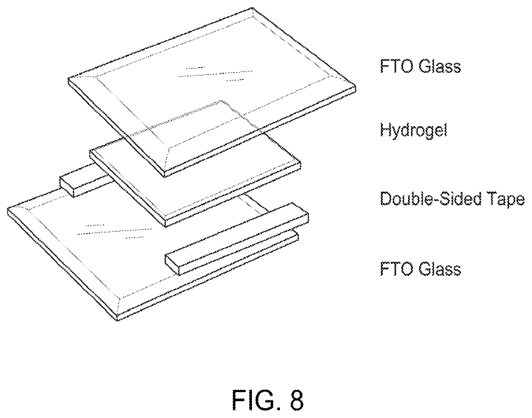

The simple CGDs were constructed by sandwiching a TTz containing PVA/borax conductive hydrogel between two pieces of clean FTO glass, while employing double sided tape (60 μm thick) as a spacer (FIG. 8). The concentration of TTz derivatives (5 mM Me₂TTz²⁺, (NPr)₂TTz⁴⁺, (SPr)₂TTz, or Bz₂TTz²⁺) was kept constant with all tests; however, the concentration of the redox complementary component, 1,1′-ferrocenedimethanol-Fc(CH₂OH)₂, was varied, yielding 1:0, 1:1, and 1:2 molar ratios to study its effect on driving voltage, reversibility, and response time. For tests lasting over 15 min, the CGDs were sealed around the edges with hot glue to minimize evaporation of water.

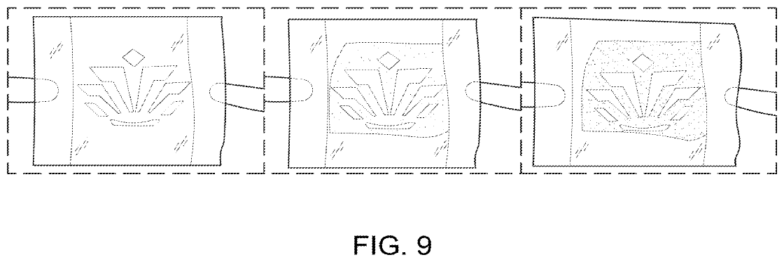

Prior to testing CGD devices, spectroelectrochemical measurements were made for (NPr)₂TTz⁴⁺ and (SPr)₂TTz in an aqueous 0.1 M Na₂SO₄ solution. Both (NPr)₂TTz⁴⁺ and (SPr)₂TTz showed a large absorbance peak around 400 nm representing the TTz²⁺ state. Upon electrochemical reduction at −0.65 V and −0.7 V (vs AgCl) for (NPr)₂TTz⁴⁺ and (SPr)₂TTz, respectively, the absorbance at 400 nm decreased, while increasing at 604 nm and 540 nm, indicative of the purple, TTz^{⋅+} state (FIG. 9). At an applied voltage of −0.9 V, the absorbance at 400 nm further decreased and a second absorption peak at 705 nm and 650 nm ((NPr)₂TTz⁴⁺ and (SPr)₂TTz, respectively) increased, signifying the visually blue, TTz⁰ state. The spectroelectrochemical data indicates that both TTz materials have excellent electrochromic reversibility. The intensity of prominent absorbance peaks (400 nm) is readily recovered after electrochemical cycling and returning the TTz²⁺ state. The two single electron reductions are easily distinguishable, similar to spectroelectrochemical results of Bz₂TTz²⁺ and Me₂TTz²⁺ obtained previously by our group. Interestingly, the two single electrochemcial reduction peaks are closely spaced for Bz₂TTz²⁺ and Me₂TTz²⁺ when run in organic solvents (DMSO and CH₃CN), and therefore exhibited only the TTz²⁺ to blue TTz⁰ visible electrochromic transition. Using the water-soluble derivatives (SPr)₂TTz and (NPr)₂TTz⁴⁺ with aqueous electrochemical conditions, the reductions show the purple (TTz^{⋅+}) singly-reduced species as well. The cyclic voltammetry of (SPr)₂TTz and (NPr)₂TTz⁴⁺ in 0.5 M Na₂SO_{4(aq)} solution confirms this observation with more separated reversible reductions at −0.54 V and −0.790 V for (SPr)₂TTz and −0.58 and −0.70 V vs. SCE for (NPr)₂TTz⁴⁺. The cycling stability was also measured showing aqueous solutions of (NPr)₂TTz⁴⁺ that could be cycled for 100 cycles on two consecutive days with minimal loss of electrochemical activity.

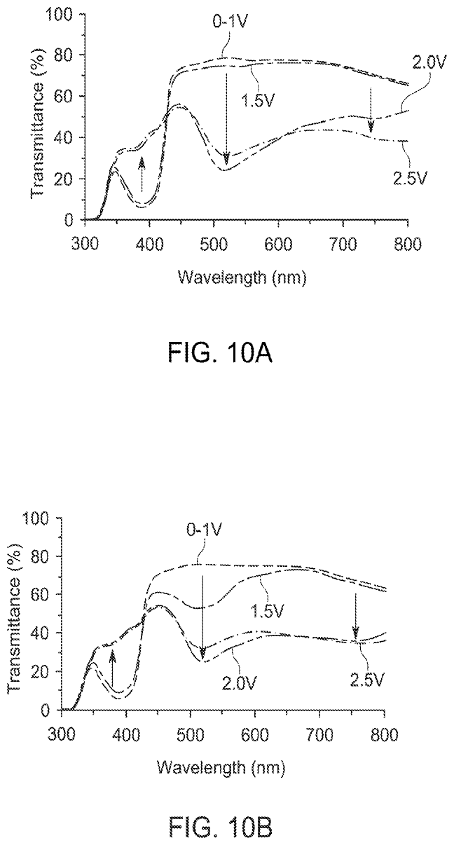

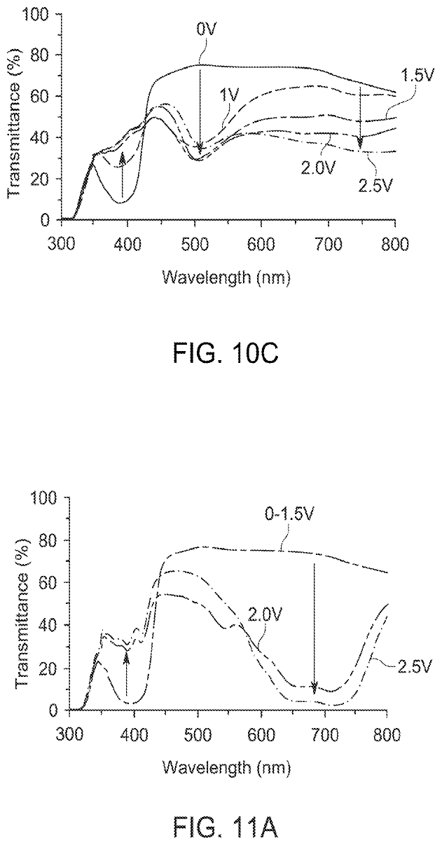

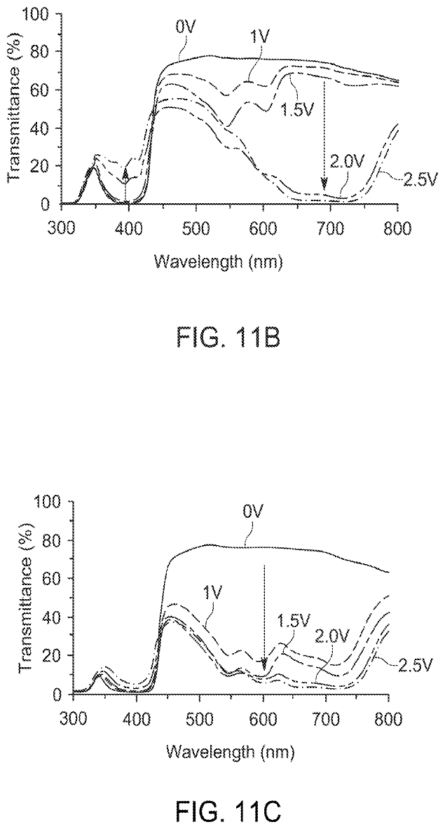

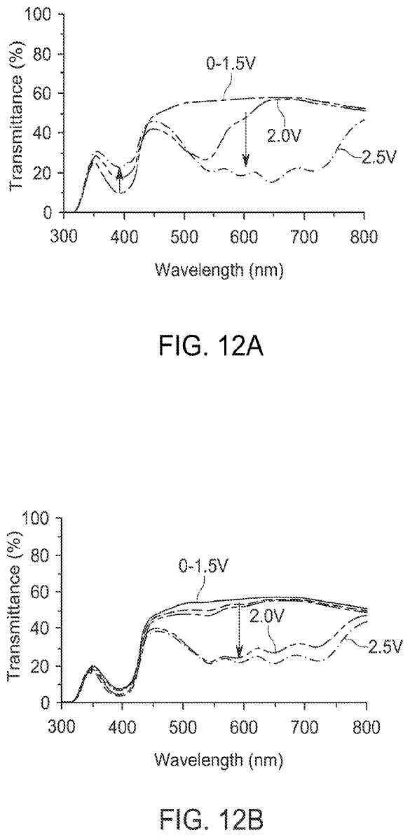

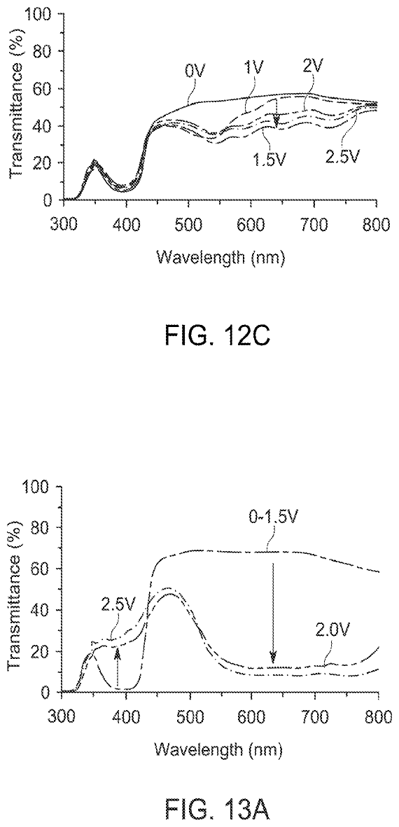

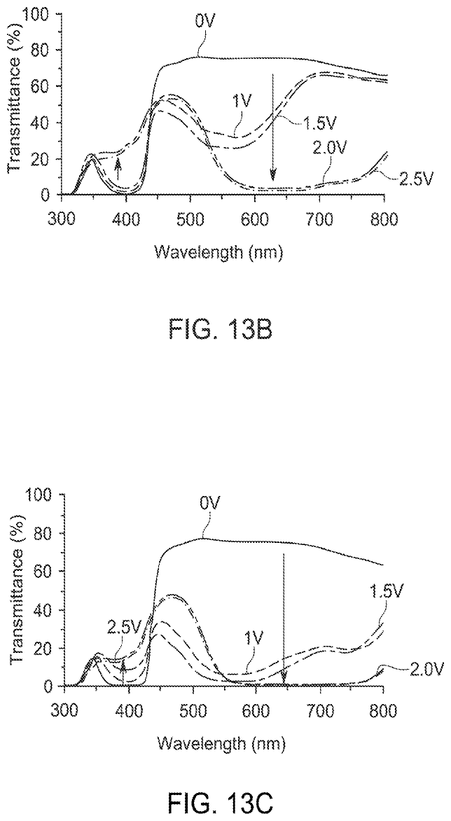

The CGDs' transmittance spectra were collected with the four different TTz derivatives and varying concentrations of Fc(CH₂OH)₂ while voltages (0 V, 1 V, 1.5 V, 2 V, 2.5 V) were applied (FIGS. 10-13). Although each TTz derivative showed absorbance intensity variations, they all followed similar trends observed in the spectroelectrochemical data, with a large absorbance around 400 nm and high transparency between 450-800 nm at 0 V represented the TTz²⁺ dication. As the applied voltage increases, a single electron reduction occurs, making the CGDs absorb more of the 500-650 nm light, corresponding to the purple, radical cation (TTz^{⋅+}) state. When applied voltage is increased further, a second reduction occurs, causing further light absorption at 500-800 nm, which appears as the visually dark blue neutral state (TTz⁰). The addition of Fc(CH₂OH)₂ lowered the amount of applied device voltage necessary for the two single electron reductions to occur by approximately 1 V.

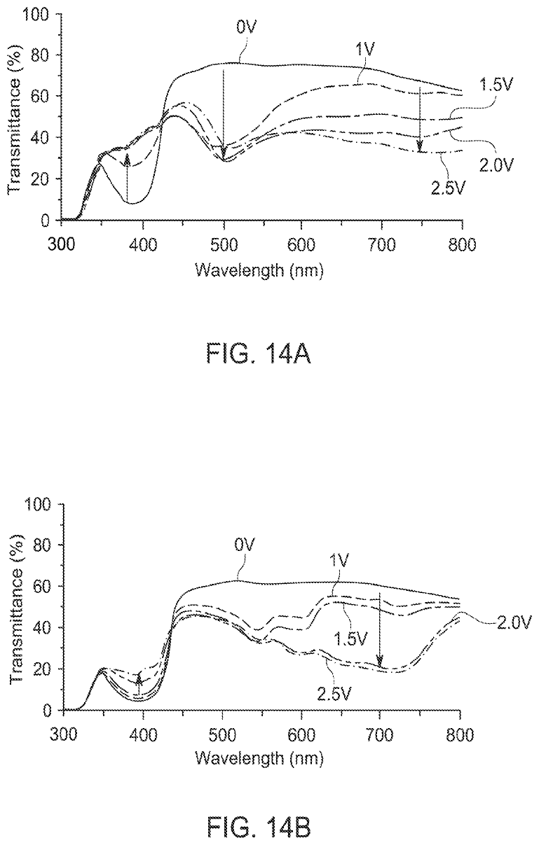

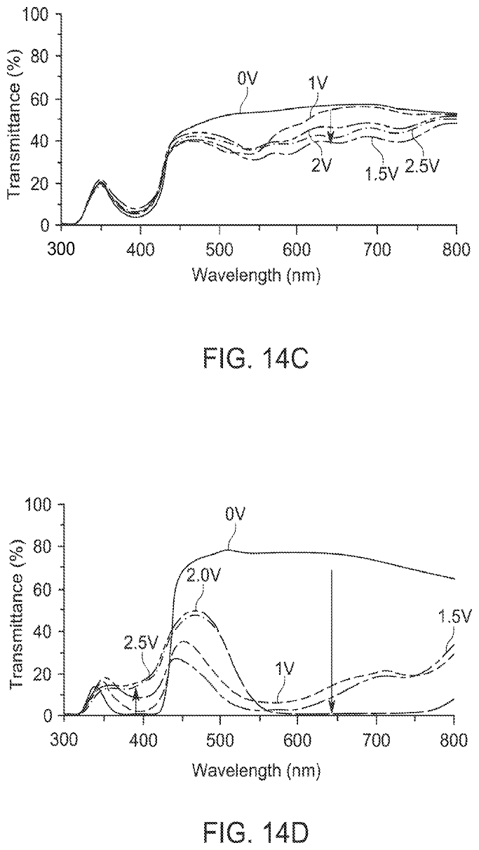

The 1:2 TTz:Fc(CH₂OH)₂ CGD transmittance spectra for the four derivatives show each TTz gives a diverse transmittance contrast and they absorb light slightly differently, depending on their side group (FIG. 14) yielding different shades of the colorless/light yellow, purple, and blue colored neutral and reduced states. The Bz₂TTz²⁺ CGD yields the greatest contrast ratio ΔT=75%, while (SPr)₂TTz showed the lowest contrast ratio of 15%. To further understand the CGDs' applied voltage dependence, the max contrast wavelength was monitored as voltage was ramped at 20 mV s⁻¹ for the individual TTz's and the various Fc(CH₂OH)₂ concentrations.

From the device spectra, the two single electron reductions can be seen. The addition of Fc(CH₂OH)₂ lowers the necessary voltage for color change, as expected, while maintaining or increasing transmittance contrast. These scans were also used to determine an “optimal voltage” for the devices, which was the lowest voltage necessary for the full contrast to the visually blue TTz⁰ state, since higher voltages of 2.5 V to 3 V slightly degraded the hydrogel.

The reversibility and cyclability of the TTz CGDs were tested by cycling the optimal voltage on/off every 20 s for 25 cycles with different ratios of TTz:Fc(CH₂OH)₂ to fully understand the complementary redox component's role in reversibility. The Me₂TTz²⁺, (NPr)₂TTz⁴⁺, and Bz₂TTz²⁺ devices show little cyclability without the Fc(CH₂OH)₂, as the TTz remains in the reduced, visually blue (off) state after several cycles. As the concentration of Fc(CH₂OH)₂ is increased, the devices become more reversible and cyclable with faster color changes, noted by the square wave characteristic with 1:2 TTz:Fc(CH₂OH)₂ devices. The 1:2 ratio was expected to yield the best results because of the balance of electron stoichiometry between the TTz and the Fc(CH₂OH)₂. Therefore, 1:2 TTz:Fc(CH₂OH)₂ hydrogels were used for the remainder of device characterization. All the TTz derivatives demonstrated high reversibility in these hydrogel CGDs and had fast coloration times of 12 s, 2 s, 3 s, and 7 s for Me₂TTz²⁺, (NPr)₂TTz⁴⁺, (SPr)₂TTz, and Bz₂TTz²⁺.

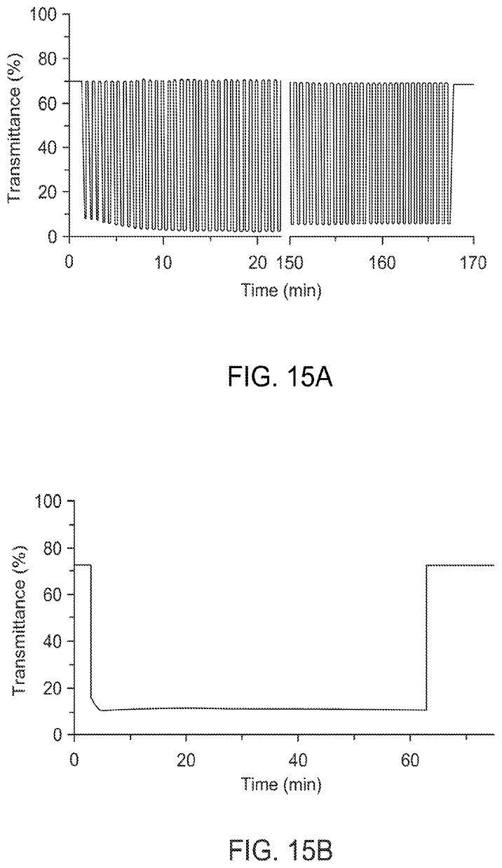

As shown in Table 2, when cycling the Me₂TTz²⁺ CGD on/off, it had an initial contrast ratio of 58% and after 25 cycles, decreased to ΔT=44%. (NPr)₂TTz⁴⁺ had an initial contrast ratio of 57% and after 25 cycles had a contrast of 60% (FIG. 15(a)). The excellent reversibility observed with the (NPr)₂TTz⁴⁺ led us to examine 250 cycles in an aqueous gel device. Remarkably, the max contrast only decreased by 6% from the max after 250 cycles (FIG. 15(a)). The lowest performing derivative, (SPr)₂TTz has an initial contrast ratio of 17% and after 25 cycles, ΔT=10%, but then reverses above the initial transmittance. The (SPr)₂TTz derivative was the least soluble derivative in the PVA/borax gel, which likely contributed to the observed low contrast cycling. The Bz₂TTz²⁺ CGD had an initial contrast ratio of 47%, which increased to 52% after 25 cycles. Previous reports demonstrated >65% contrast ratio using 20 mmol L⁻¹ ethyl viologen in a PVA/borax hydrogel device that was 200 μm thick. TTz devices such as (NPr)₂TTz⁴⁺ accomplished comparable contrast with a quarter of the concentration and a quarter of the thickness (60 μm). For large scale applications, thinner devices would require less material and weigh less, while lower concentrations mean cheaper production. This contrast ratio is also higher than a variety of previously reported viologens and polymers.

TABLE 2
CGD Electrochromic Properties

| | | | Contrast | | |
|---|---|---|---|---|---|
| | Applied | Max | difference | Colora- | Bleach- |
| | voltage | contrast | after 25 | tion | ing |
| TTz | (V) | (ΔT, λ nm) | cycles | time (s) | time (s) |
| Me₂TTz²⁺ | 2.4 | 58% (700) | −14% | 12 | 4.8 |
| (NPr)₂TTz⁴⁺ | 1.8 | 67% (710) | +3% | 2 | 1.2 |
| (SPr)₂TTz | 2.0 | 17% (600) | −7% | 3 | 0.8 |
| Bz₂TTz²⁺ | 1.8 | 52% (700) | +5% | 7 | 2.8 |

To measure durability of CGDs with long term applied voltages, their optimal voltage was applied for 60 min to study degradation losses in contrast and reversibility. The Me₂TTz²⁺ CGD has a max contrast ratio of 62% with the lowest transmittance of 9% after 11 min. The transmittance slowly increases to 13% after 60 min and the device has low reversibility. (NPr)₂TTz⁴⁺ has a contrast ratio of 62%, which is maintained for the 60 min and reverses completely to the ground state transmittance when the voltage is no longer applied (FIG. 15(b)). (SPr)₂TTz has an initial contrast ratio of 14% and slowly loses contrast during the 60 min. When the bias is removed, the transmittance does appear to recover with a slight increase from the initial transmittance. Interestingly, the Bz₂TTz²⁺ device's contrast ratio increased over the 60 min applied bias period, but when the bias was removed, it only partially recovered. The observed reduction in reversibility for several of the derivatives is possibly due to dimerization, which has been observed with similar to 4,4′-dipyridinium viologens. The Me₂TTz²⁺ may be more prone to this dimerization mechanism due to the sterically small methyl on the pyridinium groups. We have also observed slight gel discoloration of the TTz PVA/Borax hydrogels after being left at ambient conditions for more than 24 hours. However, electrochromic devices using (NPr)₂TTz⁴⁺:Fc(CH₂OH)₂ showed nearly identical spectra between a freshly-made device and one tested up to 4 days later. The discoloration can be avoided by storing the gel under N₂ or Ar inert conditions.

### Electrofluorochromism

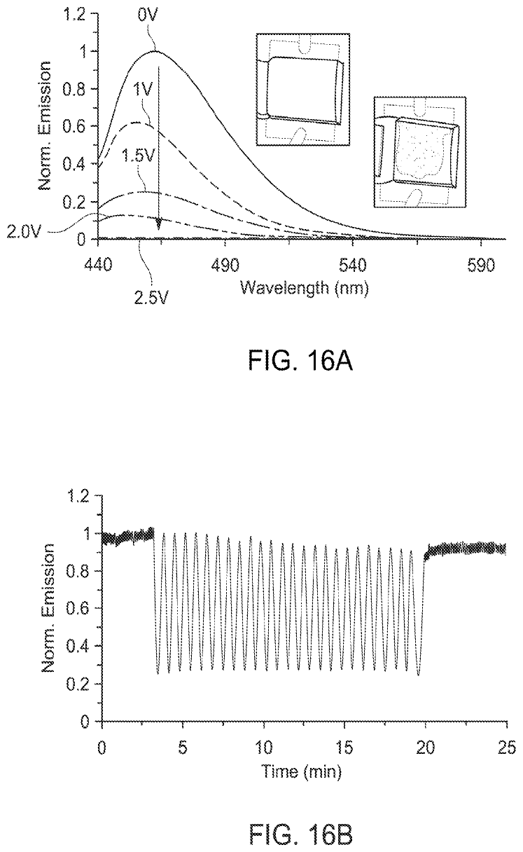

Electrofluorochromic properties of the CGDs were probed by exposing the devices to their max excitation wavelengths and applying voltages of 0 V, 1 V, 1.5 V, 2 V, and 2.5 V. All CGDs were highly fluorescent at 0 V and responsive to applied voltage with large fluorescence contrast. Although the (SPr)₂TTz CGD showed a 63% drop in fluorescence intensity between 0 V and 2.5 V, the fluorescence of the other CGDs exhibited over 90% change in emission contrast (FIG. 16(a)-Bz₂TTz²⁺). An important figure of merit for EFC's is the contrast ratio, which can be determined by comparing the max intensities or the overall fluorescence (total area) of the highly fluorescent, off (0 V) and the minimally fluorescent on (2.5 V) states (Table 3).

TABLE 3
CGD Electrofluorochromic Properties

| | | | | | | Contrast |
|---|---|---|---|---|---|---|
| | Contrast | Contrast | Fluorescence | Fluorescence | Max | difference |
| | ratio | ratio | decrease | increase | contrast | after 25 |
| TTz | (Iₒₙ/I_{off}) | (Aₒₙ/A_{off}) | time (s) | time (s) | (ΔT) | cycles |
| Me₂TTz²⁺ | 31.4 | 9.9 | 15 | 4.1 | 74% | −8% |
| (NPr)₂TTz⁴⁺ | 11.1 | 8.5 | 11 | 3.3 | 41% | +8% |
| (SPr)₂TTz | 2.7 | 3.1 | 9 | 1.3 | 47% | −13% |
| Bz₂TTz²⁺ | 143.0 | 100.5 | 15 | 9.7 | 69% | −4% |

Emission intensity contrast ratios were 31.4, 11.1, 2.7, and 143.0 for Me₂TTz²⁺, (NPr)₂TTz⁴⁺, (SPr)₂TTz, and Bz₂TTz²⁺, respectively. These emission contrast ratios are similar to previously reported small molecule EFC devices; however, Bz₂TTz²⁺ has a much larger contrast, which is ideal for sensors and fluorescent displays.

To understand the switching time, reversibility, and consistency of fluorescence switching from the “on” (0 V) and “off” (voltage applied) states, cyclability tests were performed. The applied voltage and on/off timing were the same as previously used for electrochromic cyclability. The Me₂TTz²⁺ CGD initially had a 74% contrast ratio, but over the 25 cycles, lost 8% contrast, whereas (NPr)₂TTz⁴⁺ had a 33% contrast ratio on the first cycle and gained contrast over the 25 cycles to ΔT=41%. The first cycle of the (SPr)₂TTz CGD had 47% fluorescence contrast ratio but decreased to 34% contrast ratio during the 25 cycles. The Bz₂TTz²⁺ CGD had a contrast ratio of 69% initially and maintained most contrast after 25 cycles, ΔT=65% (FIG. 16(b)). The switch time to obtain 90% full contrast for the devices was fast, 15 s, 11 s, 9 s, and 15 s for Me₂TTz²⁺, (NPr)₂TTz⁴⁺, (SPr)₂TTz, and Bz₂TTz²⁺, respectively. All the CGDs had a slight reduction in baseline emission over time due to photochromism.

### Photochromism

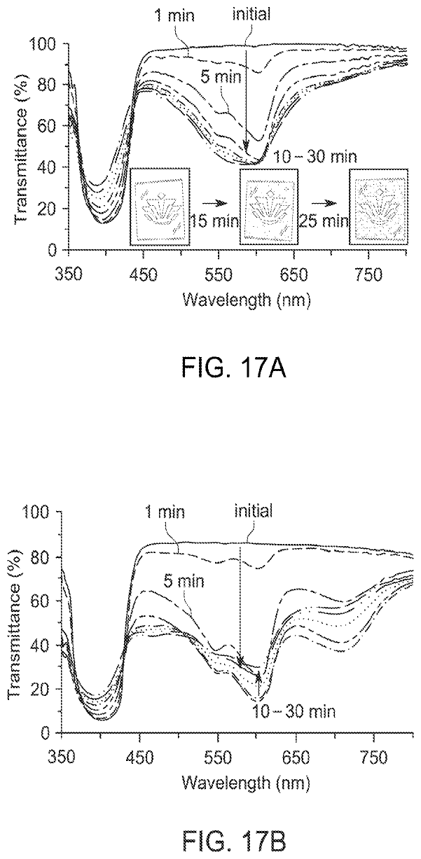

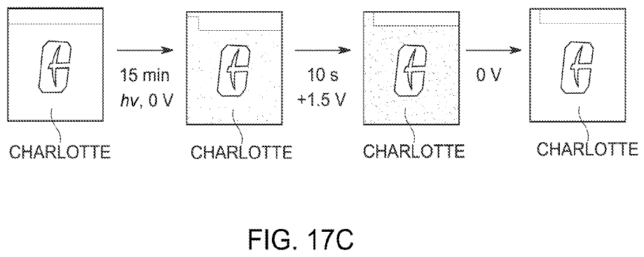

Photochromism of the CGDs was studied by the exposing TTz devices to full spectrum (one Sun) lamp illumination (approximately 100 mW cm⁻²) for 30 min with no applied bias, and intermittently measuring transmittance of light. Similar to the coloration sequence of the electrochromism studies of the CGDs, the color of the TTz device start in a colorless/light-yellow state and over time undergo photo-induced reductions to produce a final, blue-colored state. For all derivatives, a change in transmittance is caused after 5 or 10 min of light exposure (FIG. 17(a)). All four CGDs initially showed nearly 100% transparence in the 450-800 nm range, while absorbing >60% of light around 400 nm. As illumination time progressed, the devices absorbed less light at 400 nm and had less transmittance in the 500-700 nm range. The Me₂TTz²⁺ CGD had a 35% drop in transmittance at 550 nm after 15 min and only dropped an additional 3% after 30 min of light exposure, while at 395 nm the transmittance was 14% and increased to 35% after 30 min. The (NPr)₂TTz⁴⁺ CGD dropped in transmittance after 15 min at 602 nm (from 99% to 41%) with absorption broadening upon continued light exposure (FIG. 17(a)). The transmittance at 400 nm steadily increased from 13% to 35% over 30 min. The (SPr)₂TTz-containing device took the longest to reach the full color change, and had a 44% transmittance contrast at 574 nm and increased by 6% at 387 nm after 30 min. The Bz₂TTz²⁺ CGD had the fastest coloration time, which transitioned from 95% transmittance to 54% at 605 nm after only 5 min of illumination. The blue-colored state persisted between 1-2 h after illumination, however, the colorless state could be restored immediately by cycling the electrochromism of the device on and off using +1.5 V of applied bias (FIG. 17(c)).

As provided in the present example, water-based, hydrogel chromogenic devices (CGDs) were developed that show high electrochromic and electrofluorochromic contrast/reversibility while also exhibiting photochromic activity. A simple FTO/hydrogel/FTO device configuration using water-soluble dipyridinium thiazolothiazole (TTz) derivatives and a PVA/borax polyelectrolyte hydrogel yielded a multifunctional chromogenic device. Several of the devices were able to achieve 75% transmittance contrast with a driving voltage of 2 V or a contrast of 50%, just with only exposure to light. The cyclability and reversibility of the TTz CGDs is excellent losing only 6% transmittance contrast after 250 on/off cycles or 1% transmittance loss in contrast after an hour of applied voltage. In addition, it is notable that these devices operate under ambient, aqueous conditions. In the case of electrofluorochromism, >90% of the fluorescence can be turned off with the application of 2.5 V. These characteristics make the TTz CGDs promising candidates for applications in auto-darkening glass, sensors, fluorescent displays, and most suitable for windows, where the CGDs can darken on command with an applied voltage, with light exposure, or a combination of both.

### Materials and Instrumentation

Dithiooxamide, 4-pyridinecarboxaldehyde, benzyl bromide, 1,3-propanesultone, (3-bromopropyl)-trimethylammonium bromide, poly(vinyl alcohol) (PVA) M_{w} 11000-31000, methyl p-tosylate, toluene, dimethyl sulfoxide (DMSO), methanol, hexanes, Dowex Marathon A OH form anion resin (now called AmberLite), hydrochloric acid, and dimethyl formamide (DMF) were all purchased from Sigma-Aldrich and Baker Scientific while the borax used was 20 Mule Team brand. The Tec-15 FTO (fluorine doped tin oxide) glass used was purchased from Pilkington Glass. ¹H-NMR measurements were taken using a JEOL 500 MHz NMR and a JEOL 300 MHz NMR. Mass spectrometry measurements were obtained with a Perceptive Biosystems Voyager MALDI mass spectrometer. Spectroelectrochemical measurements of reduced TTz⁺² species were obtained using an EG&G Princeton Applied Research Model 173 potentiostat/galvanostat and a spectroelectrochemical cell with a 1.0 mm path, a printed platinum honeycomb working/counter electrode, and Ag/AgCl reference electrode. Potentials were applied for 15 s before UV-vis spectra were acquired using an Agilent 8453 Spectrophotometer equipped with a photo diode array detector. A Keithley 236 Source Measure Unit potentiostat, Gamry Reference 600 potentiostat, Cary 300 UV-Vis spectrophotometer, Shimadzu RF-5301PC spectrofluorophotometer and a Jobin Yvon-Spex Fluorolog spectrofluorometer were used for device spectra collection, quantum yield, and molar extinction coefficient determination. Phototochromism/photo-assisted electrochromism was measured using a Newport 67005 lamp with Newport 69911 Power Supply and an Ocean Optics QE65000 spectrometer.

### Synthesis

Synthesis of 2,5-di(pyridin-4-yl)thiazolo[5,4-d]thiazole (Py₂TTz). Dithiooxamide (0.9962 g, 8.298 mmol) and 4-pyridinecarboxaldehyde (2.2 mL, 23.35 mmol) were refluxed in 40 mL of DMF at 153° C. for 8 h in an aerated environment. The reaction mixture was cooled to room temperature, and the obtained tan precipitate was filtered via vacuum. The solid was then washed with water and dried under vacuum to give a tan solid in 72.5% yield (1.78 g). Molecular characterization data quantitatively matched previously reported values. ¹H-NMR (300 MHz, CDCl₃), 8.78 (dd, J=1.6, 4.6 Hz, 4H), 7.89 (dd, J=1.6, 4.6 Hz, 4H) ppm.

Synthesis of N,N′-Dimethyl 2,5-Bis(4-pyridinium)thiazolo[5,4-d]thiazole dichloride [(Me₂TTz²⁺)Cl₂]. Py₂TTz (0.5185 g, 1.75 mmol) and was warmed to 30° C. for 48 h in 16.3 mL of methyl p-tosylate. The precipitate was collected, washed with hexanes, and dried to yield 0.67 g (57.4% yield) of a bright yellow solid.² This solid was then treated with Dowex Marathon A anion exchange resin (Cl form). ¹H-NMR (300 MHz, CD₃CN, TMS, δ): 8.75 (d, J=6.87 Hz, 4H), 8.54 (d, J=6.87 Hz, 4H), 4.34 (s, 6H).

Synthesis of N,N′-di(trimethylaminopropyl)-2,5-Bis(4-pyridinium)thiazolo[5,4-d]thiazole tetrabromide [((NPr)₂TTz⁺⁴)Br₄]. Py₂TTz (0.2486 g, 0.8388 mmol) was refluxed with (3-bromopropyl) trimethylammonium bromide (0.552 g, 2.1153 mmol) in DMF under nitrogen at 100° C. for 72 h. The precipitate obtained was vacuum filtered and rinsed with DMF and acetonitrile, then dried in the oven to give a yellow solid (0.511 g, 74.4% yield).^{1 1} H-NMR (D₂O, 500 MHz): δ (ppm), 2.53 (m, 2H), 3.09 (s, 9H), 3.46 (t, J=8.0 Hz, 2H), 4.67 (t, J=6.5 Hz, 2H), 8.60 (d, J=5.5 Hz, 2H), 8.96 (d, J=5.5 Hz, 2H)

Synthesis of 3,3′-(thiazolo[5,4-d]thiazole-2,5-diylbis(pyridine-1-ium-4,1-diyl))bis(propane-1-sulfonate) [(SPr)₂TTz]. Briefly, Py₂TTz (115 mg) was refluxed in 1,3-propanesultone (1.25 g) at 60° C. for 6 h in air, then cooled to room temperature, yielding a solid yellow mixture. The excess sultone was removed from the solid by sonicating the reaction mixture in 3×20 mL of toluene and collecting the remaining solid via vacuum filtration. The resulting yellow solid was dissolved in H₂O and passed through a gravity filtration set-up to remove unreacted Py₂TTz. The filtrate was centrifuged for 30 min, then the liquid phase was decanted and the remaining solid was discarded. The water was then removed from the decanted solution under reduced pressure, yielding a yellow solid that was further washed with 3×25 mL of DMSO. The resulting yellow product was obtained in 33% yield (69 mg). ¹H-NMR (300 MHz, D₂O), δ 8.94 (d, J=7.2 Hz, 4H), 8.56 (d, J=7.0 Hz, 4H), 4.73 (t, J=7.4 Hz 4H), 2.94 (t, J=7.3 Hz, 4H), 2.42 (quint, J=7.4 Hz, 4H) ppm. ¹³C NMR (500 MHz, D₂O), δ 165.4, 155.6, 147.5, 145.5, 124.7, 59.9, 47.1, 26.2 ppm. MS [HR-ESI (H₂O)]: m/z calculated for C₂₀H₂₀N₄O₆S₄ 540.0266, found 540.0602.

Synthesis of N,N′-dibenzyl 2,5-bis(4-pyridinium)thiazolo[5,4-d]thiazole dichloride [(Bz₂TTz²⁺)Cl₂]: PyTTz (0.12 g, 0.41 mmol) was added to benzyl bromide (3 mL, 25 mmol) and heated at 140° C. for 6 h. The resulting solution was cooled and dissolved in 100 mL of CH₃OH, then washed with hexanes. CH₃OH was then removed to afford 0.23 g (90%) of a yellow solid, and then treated with Dowex Marathon A anion exchange resin to generate the Cl form. Molecular characterization data quantitatively matched previously reported values. ¹H-NMR (300 MHz, CD₃CN, TMS, δ): 8.89 (d, J=6.87 Hz, 4H), 8.54 (d, J=6.9 Hz, 4H), 5.78 (s, 4H), 7.52 (m, 10H).

Anion exchange: Dowex Marathon A (OH form) was treated with excess concentrated hydrochloric acid to exchange the OH anions with Cl anions, then washed with DI water. The appropriate TTz molecule was added to approximately 100 mL of H₂O and dissolved thoroughly. Dowex Marathon A, Cl form, was added to the solution in excess 2:1 mole ratio and stirred for 30 min. The resulting mixture was filtered using gravity filtration and washed with DI water. Excess water was removed through rotary evaporation.

### Spectroelectrochemistry

The blank and sample solutions were degassed with N₂ for 5 and 15 min, respectively, while in a quartz cuvette with the Ag/AgCl reference and platinum honeycomb electrode. Both forward and reverse spectra were obtained using 0.12 mM (NPr)₂TTz⁴⁺ and 0.15 mM (SPr)₂TTz in 0.1M Na₂SO₄ solutions. The spectra were obtained from 0 V to −0.9 V and −0.9 V to 0 V in 50 mV increments.

### Cyclic Voltammetry

All experiments were carried out in N₂ purged, aqueous 0.5 M Na₂SO₄ supporting electrolyte solutions using a Gamry Reference 600 potentiostat and a three-electrode setup. A 3 mm, PEEK-encased, glassy carbon or Pt disk electrode was used as the working electrode. A platinum foil was used as the counter electrode. The reference electrode consisted of a SCE suspended in saturated KCl solution. The solution of the reference electrode was separated from the analyte solution by a vicor glass frit.

### Chromogenic Device Assembly

A PVA/borax-based CG gel was obtained following a similar procedure as previously reported.³ The TTz PVA/borax gel was prepared using 5 mM TTz derivative (Me₂TTz²⁺, (NPr)₂TTz⁴⁺, (SPr)₂TTz, Bz₂TTz²⁺) added to a 0.6 mL aqueous PVA solution (4% by mass) and varying concentrations of 1,1′-ferrocenedimethanol (Fc(CH₂OH)₂) (0, 5, and 10 mM). After the solution was homogeneous via sonication or vortex, 0.1 mL of borax aqueous solution (4% by mass) was added and mixed vigorously with a spatula until the gel formed.

The prepared CG gel was coated onto one FTO glass and another FTO-coated glass was quickly placed on top of the gel, giving FTO/CG gel/FTO device configuration. The FTO glass was cleaned via sonication with water, acetone, and isopropyl alcohol in 15-min iterations and dried with N₂. Double sided scotch tape was used as a spacer (60 μm) with the FTO glass giving the active CG gel an area of 3-4 cm².

### Electrochromic Testing

Transmittance measurements of the CGDs were obtained between 300 nm and 800 nm while voltage was applied at 0 V, 1 V, 1.5 V, 2 V, and 2.5 V. After the wavelength with the highest transmittance contrast was identified, it was monitored as voltage was applied from 0 V to 2.5 V at 20 mVs⁻¹ with 100 mV steps to further understand transmittance's voltage dependence. The lowest voltage that gave high transmittance contrast and blue color was used as the “optimal voltage” for other tests since higher voltages, like 2.5 V, slightly degraded the gel. Device cyclability of the transmittance was measured as the optimal voltage was applied on and off every 20 s for 25 cycles. The optimal voltage was applied to the CGD after 3 min and was turned “off” after 63 min to determine their long-term “on”-state durability. The pH of aqueous gels was measured using pH paper test strips before and after long term electrochemical cycling. The pH was found to have changed from pH 8 before, to pH 7 after the electrochemical cycling indicating that device performance degradation was unlikely to be related to increased acidity in the polymer hydrogel.

### Electrofluorochromic Testing

EFC device fluorescence was measured using the max excitation wavelength for each TTz derivative at 0 V, 1 V, 1.5 V, 2 V, and 2.5 V while keeping the device at a 45° angle relative to the source and detector in a Shimadzu RF-5301PC spectrofluorometer. Fluorescence cyclability of CGDs was measured front facing with the CGD 90° to the source and detector in the Jobin Yvon-Spex Fluorolog as the optimal voltage was applied on/off every 20 s for 25 cycles. The max excitation and emission wavelengths for each respective TTz were used to monitor fluorescence switching.

### Photochromic Testing

Photochromic properties of the CGDs were observed while placed underneath an AM 1.5 lamp for 30 min. The spectrophotometer was blanked with a PVA/Borax device with no chromogenic compounds. To identify voltage assisted photochromism, the transmittance of the CGD was then measured as a function of applied maximum voltage at which electrochromism does not occur.

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A composite composition comprising:
one or more chromogenic thiazolothiazoles contained in an aqueous-based polyelectrolyte matrix.

2. The composite composition of claim 1, wherein the one or more chromogenic thiazolothiazoles are soluble in the aqueous-based polyelectrolyte matrix.

3. The composite composition of claim 1, wherein the one or more chromogenic thiazolothiazoles include a thiazolo(5,4-d)thiazole heterocycle structure.

4. The composite composition of claim 1, wherein the one or more chromogenic thiazolothiazoles comprise at least two pyridinium moieties.

5. The composite composition of claim 1, wherein the aqueous-based polyelectrolyte matrix comprises a hydrogel.

6. The composite composition of claim 5, wherein the one or more chromogenic thiazolothiazoles are soluble in the aqueous-based phase of the hydrogel.

7. The composite composition of claim 5, wherein the one or more chromogenic thiazolothiazoles are incorporated into polyelectrolyte of the hydrogel.

8. The composite composition of claim 7, wherein the one or more chromogenic thiazolothiazoles are incorporated into the polyelectrolyte backbone.

9. The composite composition of claim 7, wherein the one or more chromogenic thiazolothiazoles are incorporated as side chains of the polyelectrolyte.

10. The composite composition of claim 7, wherein the one or more chromogenic thiazolothiazoles are crosslinkers in the hydrogel.

11. The composite composition of claim 1, wherein the one or more chromogenic thiazolothiazoles are symmetric.

12. The composite composition of claim 1, wherein the one or more chromogenic thiazolothiazoles are asymmetric.

13. The composite composition of claim 1, wherein the one or more chromogenic thiazolothiazoles undergoes a first color change in response to a first electron reduction, and a second color change in response to a second electron reduction.

14. The composite composition of claim 13, wherein the first and second color changes are reversible via oxidation.

15. The composite composition of claim 13, wherein the first and second color changes occur in the visible region of the electromagnetic spectrum.

16. The composite composition of claim 1 further comprising a redox complimentary component.

17. The composite composition of claim 16, wherein a ratio of the chromogenic thiazolothiazoles to the redox complimentary component ranges from 1:0.1 to 1:5.

18. The composite composition of claim 1, wherein the one or more chromogenic thiazolothiazoles are at least one of electrochromic, electrofluorochromic, and photochromic.

19. A chromogenic device comprising:
an active layer arranged between a first electrode and a second electrode, the active layer comprising one or more chromogenic thiazolothiazoles contained in an aqueous-based polyelectrolyte matrix.

20. The chromogenic device of claim 19, wherein the one or more chromogenic thiazolothiazoles are soluble in the aqueous-based polyelectrolyte matrix.

21. The chromogenic device of claim 19, wherein the one or more chromogenic thiazolothiazoles include a thiazolo(5,4-d)thiazole heterocycle structure.

22. The chromogenic device of claim 19, wherein the one or more chromogenic thiazolothiazoles comprise at least two pyridinium moieties.

23. The chromogenic device of claim 19, wherein the aqueous-based polyelectrolyte matrix comprises a hydrogel.

24. The chromogenic device of claim 19, wherein the one or more chromogenic thiazolothiazoles are soluble in the aqueous-based phase of the hydrogel.

25. The chromogenic device of claim 19, wherein the one or more chromogenic thiazolothiazoles undergoes a first color change in response to a first electron reduction, and a second color change in response to a second electron reduction.

26. The chromogenic device of claim 25, wherein the first and second color changes are reversible via oxidation.

27. The chromogenic device of claim 25, wherein the first and second color changes occur in the visible region of the electromagnetic spectrum.

28. The chromogenic device of claim 25, wherein at least one of the first and second electrodes is radiation transmissive.

29. The chromogenic device of claim 28, wherein at least one or the first and second electrodes comprises a radiation transmissive conducting oxide.

30. The chromogenic device of claim 19, wherein a change in active layer transmittance between oxidized and two electron reduced forms of the chromogenic thiazolothiazoles is at least 50 percent at one or more wavelengths in the visible region of the electromagnetic spectrum.

31. The chromogenic device of claim 30, wherein the change in active layer transmittance is 55-80 percent.

32. The chromogenic device of claim 30, wherein the change in active layer transmittance at one or more wavelengths in the visible region is 55-80 percent after cycling the chromogenic thiazolothiazoles between oxidized and reduced forms at least 25 times.

33. The chromogenic device of claim 19, wherein the active layer further comprises a redox complimentary component.

34. The chromogenic device of claim 19 further comprising a power source connected to the electrodes.

35. The chromogenic device of claim 19, wherein the device is at least one of electrochromic, electrofluorochromic, and photochromic.

36-45. (canceled)
